(19) United States
(12) Patent Application Publication
(10) Pub. No.: US 2023/0213220 A1
(43) Pub. Date: Jul. 6, 2023

(54) AIR TREATMENT APPARATUS WITH ELECTROSTATIC PRECIPITATION FUNCTION

(71) Applicant: Woco GmbH & Co. KG, Bad Soden-Salmuenster (DE)

(72) Inventors: Anton Wolf, Gelnhausen (DE); Pia Engelhardt, Heusenstamm (DE); Dennis Van Dekken, Gelnhausen (DE)

(73) Assignee: Woco GmbH & Co. KG, Bad Soden-Salmuenster (DE)

(21) Appl. No.: 17/998,200

(22) PCT Filed: Apr. 22, 2021
(86) PCT No.: PCT/EP2021/060579

§ 371 Date: Nov. 8, 2022

(30) Foreign Application Priority Data
May 8, 2020 (DE) 10 2020 112 573.9

(51) Int. Cl. F24F 6/04; F24F 8/142; F24F 8/192; F24F 8/98; F24F 11/72; B03C 3/36; B03C 3/41; B03C 3/53; B03C 3/60

(52) U.S. Cl. CPC F24F 6/04; F24F 8/142; F24F 8/192; F24F 8/98; F24F 11/72; B03C 3/368; B03C 3/41; B03C 3/53; B03C 3/60; F24F 2006/001

(57) ABSTRACT

An apparatus for treating air, such as an air humidifier, air cleaner, air washer or the like, may include a rinse-around body around which liquid rinses, an air conduction system arranged to stream the air to be treated against the rinse-around body, and an electrostatic precipitator assigned to the rinse-around body such that solid and/or liquid particles are precipitated from the air to be treated streaming against the rinse-around body and that the precipitated particles enter the liquid.

### CROSS REFERENCE TO RELATED APPLICATIONS

This patent application is a U.S. National Stage application of International Application No. PCT/EP2021/060579, filed Apr. 22, 2021, which claims priority to German Patent Application No. 10 2020 112 573.9, filed May 8, 2020, each of which is incorporated herein by reference in its entirety.

### BACKGROUND

### Field

The present disclosure relates to an apparatus and a method for treating, in particular humidifying, cleaning and/or washing, air, such as an air humidifier, an air cleaner, an air washer or the like.

### Related Art

Air treatment apparatuses of this kind serve to treat, in particular to clean, humidify and/or wash, air which is present in closed rooms and/or buildings. The air treatment apparatuses can have numerous fields of application, for example in medical technology or in the healthcare industry, in particular in medical practices, isolation rooms, hospital rooms, intensive care units or clean rooms, in private households, in particular in bedrooms, living rooms, kitchens or children's rooms, in public or industrial buildings, such as museums, theaters, government buildings or offices, and/or in mobility, for example for cleaning vehicle interiors, in particular in cabs, rental cars or vehicle sharing concepts. For example, the air treatment apparatuses are stand-alone devices and/or small electric devices, which can be placed on the floor or also on shelves, such as tables, in buildings or rooms.

Normally, air cleaners are equipped with multi-layer filter systems. Thereby, a highly effective suspended matter filter is supplemented by additional filters so that the intake room air is cleaned and relieved from pollutants. Air washers, on the other hand, usually work without additional filters and pass the air through a water bath, where it is cleaned and humidified at the same time.

DE 196 21 996 A1 discloses an air humidifier with a liquid reservoir from which liquid is pumped by means of a riser pipe to a top of a curved air-stream surface made of glass. The water flows off the airstream surface and humidifies streaming air. The water then flows back into the liquid reservoir via a discharge edge.

Increasingly stringent demands are being placed on air treatment. This is due on the one hand to increasingly stringent legal requirements and on the other to the steadily growing health awareness of the population. Particularly the fine dust present in the air, which comprises solid particles in the μg/m3 range, has proven to be especially critical. Fine dust can also contain bacteria, pollen, viruses, spores, fibers and the like. There are generally two classes of air treatment apparatuses, namely passive air treatment apparatuses and active air treatment apparatuses. Passive air treatment apparatuses do not introduce additional energy into the system to treat the air. Active air treatment apparatuses are characterized by the fact that additional energy is applied to perform the air treatment. Known air treatment apparatuses are limited in their effectiveness with respect to air treatment. In particular, the passive systems are not capable of effectively separating the fine dust particles from the air too.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 is an apparatus according to an exemplary embodiment of the disclosure.

FIG. 2 is a perspective view of an apparatus according to an exemplary embodiment of the disclosure.

FIG. 3 is a partial perspective view of the apparatus of FIG. 1, according to an exemplary embodiment of the disclosure.

FIG. 4 is a partial perspective view of the apparatus of FIGS. 2 and 3, according to an exemplary embodiment of the disclosure.

FIG. 5 is a partial perspective view of an apparatus according to an exemplary embodiment of the disclosure.

FIG. 6 is a sectional view of the apparatus of FIG. 5, according to an exemplary embodiment of the disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the present disclosure is to improve the disadvantages from the known prior art, in particular to provide a flexibly applicable and more effective air treatment apparatuses.

According to this, an apparatus for treating, in particular cleaning, humidifying and/or washing air is provided. The air may, for example, be provided with solid and/or liquid particles, in particular impurities, which can be at least partially separated from the air by means of the apparatus according to the disclosure. The air is in particular air which is present in closed rooms and/or buildings, such as room air, and with which people can come into direct contact. In an exemplary embodiment, the air treatment apparatus is a small electrical device and/or a stand-alone device which can be installed in buildings or rooms or which can be integrated into a room and/or building ventilation system, such as a vehicle interior ventilation system. In addition to the possibility that the air treatment apparatus can be designed as an independent apparatus, in particular a stand-alone device, it is also possible to integrate the air treatment apparatus according to the disclosure into ventilation systems, extractor hoods or other ventilation systems assigned to a room, a building or a space of a vehicle. The apparatus has exemplary dimensions in the range of 100 mm to 500 mm in height×50 mm to 300 mm in width×50 mm to 300 mm in depth. The apparatus may be capable of removing liquid particles, such as grease or oil particles, and fine particulate solid particles from the air, even for solid particle concentrations in the microgram per cubic meter range. In particular, the apparatus is capable of complying with fine dust limits, with a fine dust limit PM10 of 40 micrograms per cubic meter being achievable, for example. Fine dust particles are understood to be particles with an aerodynamic diameter of 10 micrometers or smaller.

The apparatus according to an exemplary embodiment of the disclosure may include a rinse-around body around which liquid can rinse, in particular rinses. The rinse-around body can be electrically conductive. For example, the rinse-around body has at least in sections an electrically conductive surface and/or electrically conductive surface coating. For example, the apparatus may comprise operating modes, such as an off mode or a predetermined active operating mode, in which the rinse-around body is not rinsed. The fluid may be supplied from a reservoir associated with the apparatus, a separate fluid storage or reservoir, or otherwise. The liquid is generally a flowable rinsing and/or collector medium, for example, water, in particular also rainwater, a hygroscopic collecting material, such as sodium hydroxide dissolved in a liquid, a gel, which is heated, for example, to a certain temperature, so that a liquid aggregate state is reached, such as a wax or similar, an ionic liquid, such as molten or dissolved salts, or also highly viscous oils, which are loaded with electrically conductive particles, such as copper, are used. For example, the fluid may have a predetermined minimum electrical conductivity, for example of at least 0.005 S/m. In an exemplary embodiment, the rinse-around body is rotatably supported and may be coated or charged with the fluid, particularly continuously, during rotation. For example, the rinse-around body may be sprayed with liquid at its surface or may be partially immersed in a liquid or gel bath so as to be continuously wetted with the liquid at its surface. When the rinse-around body is immersed in the liquid bath, a liquid film forms on the surface of the rinse-around body, which adheres to the surface of the rinse-around body during rotation and is finally released back into the liquid bath in the course of rotation, namely when the corresponding section of the rinse-around body is immersed in the liquid bath again.

For example, the rinse-around body can be essentially hollow and/or have curved outer surfaces and/or outer surfaces that are inclined at least with respect to a vertical direction, in particular flow-off surfaces. For example, the rinse-around body can be shaped such that provided liquid distributes itself substantially independently, in particular uniformly, and/or rinses around the rinse-around body substantially completely, in particular uniformly. Furthermore, it may be possible to associate an additional liquid distribution device with the rinse-around body, which applies the liquid to the rinse-around body and ensures reliable rinsing. For example, the rinse-around body can be supplied with liquid at its uppermost point, in particular as viewed with respect to a vertical direction, which can define a distribution surface, and from there flow off independently, in particular uniformly, at the rinse-around body and rinse around it.

Furthermore, in an exemplary embodiment, the apparatus may include an air conduction system which is adapted to stream the air to be treated onto the rinse-around body, in particular to stream it around the rinse-around body. During the stream around, it can be provided that the air flows against the rinse-around body, in particular completely around the rinse-around body, in particular in such a way that a flow-off surface of the rinse-around body, which is rinsed by liquid, is in particular completely exposed to the air to be treated. The air conduction system can, for example, define or limit an air duct through the apparatus and/or past the rinse-around body and/or out of the apparatus again. The air conduction system can, for example, have at least one inlet via which air, in particular ambient air, such as room air, can flow into the apparatus, an outlet via which the air treated by the apparatus can leave the apparatus again, and/or comprise an air duct within the apparatus for, in particular, selectively guiding air within the apparatus. In particular, the air is guided directly past the rinse-around body, in particular the air channel is delimited by the rinse-around body at least in sections.

According to the disclosure, the air treatment apparatus may include an electrostatic precipitator. In an exemplary embodiment, the electrostatic precipitator operates substantially according to the following principle: release of electric charges, in particular electrons; charging of particles that may be present in the air in an electric field; transport of the electrically charged particles to an opposite pole; discharge of the charged particles at the opposite pole; and removal of the particles from the opposite pole. For example, the electrostatic precipitator may generate a high voltage electric field, particularly in the range of 8 to 16 kilovolts, preferably in the range of 11 to 14 kilovolts. By way of example, the underlying charge generation principle of the electrostatic precipitator may be impact ionization. When a so-called corona operating field strength is exceeded, electrons can be released and interact with the surrounding gas molecules of the air, forming a negative corona. Free electrons present in the air are strongly accelerated in the electrostatic field of the corona, so that a gas discharge can occur. Upon impact with gas molecules in the air, additional electrons may be split off or attach to the gas molecules. The negative charges move within the air treatment apparatus, particularly within the electrostatic precipitator. When an air stream loaded with particles enters, the negatively charged charges attach to the particles. Due to the acting electrostatic force of the applied DC field, which may be oriented transverse to the direction of air flow within the apparatus, the negatively charged particles are deflected and can thus be separated from the air stream. The present disclosure also covers embodiments in which a positive corona or positively charged charge is generated instead of the negative corona or negatively charged charges, respectively. To avoid repetition, the description of the disclosure is limited to the embodiment of the negative charge situation.

According to the disclosure, the electrostatic precipitator is assigned to the rinse-around body in such a way that solid and/or liquid particles are precipitated from the air to be treated streaming against the rinse-around body and that the precipitated particles enter the liquid. The inventors of the present disclosure have succeeded in integrating electro precipitation technology for highly effective and efficient precipitation of liquid and/or solid particles from an air stream into an air treatment apparatus, such as air humidifiers, air cleaners, air washers or the like. In this way, the air cleaning effect, in particular the precipitation effect, of such apparatuses can be significantly increased. Expensive filters, such as HEPA filters, can be dispensed with, so that the operation of the air treatment apparatus requires less maintenance and is thus more cost-effective. Furthermore, the combination of the rinse-around body around which liquid rinses and the assignment of the electrostatic precipitator to the rinse-around body creates a kind of self-cleaning function. The precipitated solid and/or liquid particles can be collected selectively. For example, the solid and/or liquid particles are entrained by the rinsing liquid or sediment in it. Subsequent cleaning of the apparatus, in particular cleaning of the liquid, is possible in a simple manner. Furthermore, the electrostatic precipitator is protected from contamination. A further advantage of the air treatment apparatus according to the disclosure is that any bacteria, pollen, viruses, spores, fibers or the like contained in fine dust can be precipitated. The air treatment apparatus can thus also have a medical application. In the event that the rinse-around body is rotatably mounted in a liquid bath, it can thus be ensured that, as a result of the rotation, the particles precipitated into the liquid film on the rotating rinse-around body can be continuously released into the liquid bath and collected there.

In an exemplary embodiment of the present disclosure, the apparatus includes a local fluid reservoir. By local is meant that the fluid reservoir is part of and/or directly associated with the apparatus as opposed to a separate fluid reservoir or supply. For example, the liquid reservoir is arranged below the rinsing body. On the one hand, this results in a compact structure for the air treatment apparatus, and on the other hand, the rinse liquid can flow back into the liquid reservoir in a structurally simple manner using the gravitational forces.

In a further exemplary embodiment of the apparatus according to the disclosure, the liquid reservoir is integrated into a liquid circuit in such a way that the liquid, which may be contaminated with particles, can return to the liquid reservoir after the rinse-around body has been rinsed. The precipitated particles can be entrained by the rinse liquid and transported into the liquid reservoir where they are collected. Known electrostatic precipitators generally have the disadvantage that they become clogged with the precipitated particles, i.e. polluted, so that the precipitating effect of the electrostatic precipitator is reduced. The rinsing liquid prevents the precipitated particles from accumulating and depositing on components of the electrostatic precipitator and releases the particles selectively, namely into the liquid reservoir.

In an exemplary further embodiment of the present disclosure, it is possible that the liquid, which may be contaminated with particles, is filtered before it is fed to the rinse-around body in order to remove the particles precipitated from the air from the liquid. Further, it is possible to replace collection pool for precipitated particles developing in the fluid reservoir at certain time intervals.

According to an exemplary further development of the air treatment apparatus according to the disclosure, the rinse-around body is substantially completely surrounded by an at least intermittently moving, in particular continuously flowing liquid film. The liquid film can, for example, have a film thickness in the range from 0.1 mm to 1 mm.

In a further exemplary embodiment of the air treatment apparatus according to the disclosure, the rinse-around body is convexly curved at least in sections. For example, at least that surface of the rinse-around body which is supplied with liquid and from which the liquid is distributed in particular uniformly around the rinse-around body, also referred to as the distribution surface, is convexly curved. For example, the rinse-around body is rotationally symmetrical in shape. The rinse-around body can have an oval or spherical shape. It is also conceivable that the rinse-around body comprises an umbrella-like or dome-like flow-off surface.

According to an exemplary further development, the rinse-around body is rotationally symmetrical and has a central distribution surface from which the liquid spreads out in particular uniformly in order to flow off the rinse-around body in particular uniformly. The distribution surface may define a highest point of the rinse-around body with respect to a vertical direction. The distribution surface may be formed as a substantially planar surface with low convexity. The convexity of the flow-off surface may gradually increase starting from the distribution surface. According to an exemplary further embodiment, the rinse-around body is shaped such that the liquid rinses, in particular completely, around it substantially by itself. It should be understood that the liquid is first to be supplied to the rinsing body, in particular from the liquid reservoir, for example to the distribution surface. However, the rinse-around body can be shaped in such a way that the liquid is distributed essentially exclusively by using the gravitational force, in particular uniformly, on the rinse-around body and/or flows around it or down it and, if necessary, flows back into the liquid reservoir.

According to an exemplary further development of the air treatment apparatus according to the disclosure, a central opening is provided in the distribution surface, which is connected to the liquid reservoir via a liquid channel. For example, a liquid conveying device, such as a pump, is integrated into the liquid channel to pump liquid from liquid storage, for example to the distribution surface of the rinse-around body. A valve device may further be coupled to the pump. Via the central opening, the liquid leaves the liquid channel and spreads out, in particular uniformly, at the distribution surface, in order to flow around the latter, in particular uniformly, and/or to flow off at the latter, in particular uniformly. The central opening may, for example, be located at the highest point of the distribution surface. It is further possible to support the distribution surface gimbally, in particular by means of a gimbal suspension or bearing, so that it can be ensured that the central opening can be reliably supplied with the fluid and/or is located at the highest point.

In another exemplary embodiment of the present disclosure, the air treatment apparatus comprises a liquid conveying device, such as a pump, for in particular continuously rinsing liquid around the rinse-around body. The pump may comprise an active mode in which liquid is continuously conveyed, in particular pumped, towards the rinse-around body. Furthermore, the pump can comprise a passive mode in which pumping or conveying operation is prevented and the rinse-around body is thus not supplied with liquid. The liquid conveying apparatus can further be designed to convey, in particular to pump, preferably continuously, liquid from the liquid reservoir to a highest point of the rinse-around body, in particular to the distribution surface. The liquid can then flow off the rinse-around body surface from the highest point, in particular of the distribution surface, essentially exclusively under the influence of the gravitational force, in order to rinse around the rinse-around body, in particular uniformly, and/or to form a, in particular uniform, at least intermittently moving liquid film on the rinse-around body surface.

According to another exemplary embodiment of the apparatus according to the disclosure, the air conduction system comprises an air conveying device, in particular an air suction device, such as a fan. A fan is generally understood to be a fluid machine that builds up a pressure ratio between 1 and 1.3 between the intake side and the pressure side in order to convey air. The air conveying device may be arranged to draw in air from the environment and/or to convey air towards the electrostatic precipitator. In particular, the air conveying device is capable of or intended to suck the air to be treated, in particular building and/or room air, into the apparatus and to feed it to or expose it to the electrostatic precipitator in order to subject the air to be treated to an electrostatic precipitation process to precipitate solid and/or liquid particles from the air to be treated, so as to clean the air to be treated. Thereby, it may be provided that the air conveying device is arranged above the rinse-around body. An air conveying device through the apparatus, in particular in the area of the electrostatic precipitator, can thereby be oriented essentially in the vertical direction. This results above all in a particularly compact design of the air treatment apparatus, so that it can be enclosed in a compact structure in a constructively simple manner, so that the air treatment apparatus is also suitable for small electrical devices, for example, in order to be placed in offices and/or on tables or to be placed on a shelf.

According to an exemplary further development of the present disclosure, the air treatment apparatus comprises a housing, in particular a multi-part housing. The housing may be made of plastic, in particular injection-molded. The housing completely accommodates the rinse-around body and the electrostatic precipitator, as well as optionally the liquid storage tank, optionally the air conveying device and/or optionally the liquid conveying device. The housing can prevent access from the outside to the individual components of the air treatment apparatus. The accommodation of the individual components in a housing can be advantageous, particularly with regard to the application of the air treatment apparatus as an electric small/stand-alone device for building rooms. Via the multi-part design of the housing, it can be ensured, for example, that the individual components can be mounted or demounted separately. For example, a housing part is assigned to the rinse-around body and the electrostatic precipitator, another housing part is assigned to the liquid storage device and the liquid conveying device, and an additional housing part is assigned to the air conveying device, if applicable, wherein assigned means that the corresponding housing part essentially surrounds the corresponding component of the air treatment apparatus. The housing may also have a bottom, such that the housing is closed at the bottom. For example, the bottom is made in one piece with the housing part for the liquid storage device and possibly the liquid conveying device, in particular made by means of a plastic injection molding process. The individual housing parts may comprise connection parts for connecting the individual housing parts, in particular for quick connection, such as form-fit and/or force-fit connections. For example, plug-in and/or snap-in connections are conceivable.

In a further exemplary embodiment of the air treatment apparatus according to the disclosure, the air treatment apparatus comprises a housing, in particular a multi-part housing, in which at least the rinse-around body and the electrostatic precipitator are accommodated. The air conduction system has a plurality of air passage recesses in the housing. In other words, air passage recesses are provided in the housing, which are part of the air conduction system, in particular for sucking in air from the environment and/or discharging air again towards the environment, in particular for humidifying the room. The air passage recesses can be incorporated in the housing in such a way that a high level of air can be effectively drawn in and introduced into the apparatus by means of the air conveying system, so that a highest possible level of air can be treated and/or cleaned of solid and/or liquid particles. Thereby, it can also be ensured that a high degree of air humidification is realized.

In another exemplary embodiment of the air treatment apparatus according to the disclosure, the electrostatic precipitator comprises at least one emission electrode and at least one counter electrode assigned to the emission electrode. The counter electrode and the emission electrode may be insulated from each other and/or each may be made from a single piece. The emission electrode, also referred to as the spray electrode, serves essentially to emit, in particular, negatively charged particles. The counter electrode, also called the precipitation electrode, forms the opposite pole. An electrical high voltage can be applied to the at least one emission electrode and the counter electrode, so that a high-voltage electrical field can be generated between the emission electrode and the counter electrode. For example, the high voltage is in the range of 8 to 16 kV. For example, the space between the emission electrode and the counter electrode may be referred to as the precipitation space, in which the solid and/or liquid particles are precipitated from the air stream. During operation of the electrostatic precipitator, a high voltage electrical field is applied between the at least one emission electrode and the counter electrode, such that a high voltage field is generated between the emission electrode and the counter electrode. In particular, the electrostatic precipitator is operated below the breakdown voltage or flashover voltage. The breakdown voltage, also known as the flashover voltage, is the voltage that must be exceeded for a voltage breakdown to occur through a material or substance, for example an insulator or gas. When the so-called corona operation field strength is exceeded, electrons escape from the emission electrode and interact with the surrounding air molecules, forming a so-called negative corona. Free electrons present in the air are strongly accelerated in the electrostatic field of the corona, so that a gas discharge can occur. Upon impact with air molecules, further electrons can be split off or attach themselves to the air molecules. The negative charges then move towards the neutrally charged counter-electrode. The counter electrode can, for example, be grounded and/or at ground potential. When a particle loaded gas stream enters, the negatively charged charges attach themselves to the particles. Due to the acting electrostatic force of the DC field transverse to the direction of flow of the air stream through the air treatment apparatus, the negatively charged particles migrate towards the counter electrode, where they can release their charge again. The air stream cleaned of the particles can leave the electrostatic precipitator and, in particular, the air treatment apparatus, while at the same time the air to be treated is humidified due to the rinsed rinse-around body, so that air humidification of the room is accompanied. The counter-electrode can be formed, for example, by the rinse-around body provided with electrical conductivity. The rinse-around body may be electrically conductive. For example, the rinse-around body has, at least in sections, an electrically conductive surface and/or an electrically conductive surface coating.

According to the exemplary embodiment, the counter-electrode is formed by the rinse-around body. The rinse-around body can be made of an electrically conductive material such as metal, in particular stainless steel. The rinse-around body thereby performs several functions: The rinse-around body is part of the electrostatic precipitator and forms the opposite pole for building the electrostatic field for separating particles from the air stream; Furthermore, the rinse-around body is responsible for the liquid circulation, which serves to clean the counter-electrode, i.e. to avoid deposits of the precipitated particles on the counter-electrode surface, and also for the function of the air treatment apparatus according to the disclosure for air humidification. In an exemplary embodiment, the at least one emission electrode is assigned to the rinse-around body in such a way that particles precipitated from the air are attracted to the rinse-around body. The electrical charging of the particles in the electrical high-voltage field can thus be used to separate the charged particles from the air stream, so that an air stream that has been essentially cleaned of particles can be discharged from the apparatus and fed back into the room, for example using air humidification for setting a desired humidity level within the room.

According to the exemplary development, the electrostatic precipitator includes a large number of emission electrodes. For example, the plurality of emission electrodes form an emission electrode array. For example, the term “array” is to be understood as a specific arrangement of the emission electrodes, with the emission electrodes being arranged, for example, in several, in particular two, rows of several emission electrodes. For example, the emission electrodes are in particular distributed uniformly and/or arranged in a ring-like manner around the particularly rotationally symmetrical rinse-around body. For example, the emission electrode array covers a fraction of the body surface area. This can be understood to mean that a projected area of the multiplicity of emission electrodes on the rinse-around body is only a partial area of significantly less than 50%, in particular less than 30%, less than 20% or less than 10% of the entire rinse-around body surface. The emission electrodes are arranged at a distance from the rinse-around body, respectively the counter electrode, viewed transversely to the direction of flow of the gas stream, as a result of which in particular the separation space is formed.

In a further exemplary embodiment of the apparatus according to the disclosure, the at least one emission electrode, in particular the plurality of emission electrodes, is arranged in the region from a highest point of the rinse-around body, in particular as viewed from the distribution surface, to a quarter, in particular in the range from a quarter to three quarters, in particular at about half, of an axial, in particular a vertical, height of the rinse-around body and/or is attached to an inner side of the housing. In particular, the at least one emission electrode is attached in such a way that a distance transverse to the stream direction is set between the emission electrodes and the counter electrode. The larger the rinse-around surface of the rinse-around body, the better the air to be treated can be humidified. The larger also the precipitation space formed by the electrostatic precipitator, which can be adjusted by dimensioning the emission electrodes, in particular the emission electrode array, the higher the precipitation rate for precipitating particles from the air stream. The air treatment apparatus according to the disclosure can further be designed, in particular the electrostatic precipitator and the rinse-around body can be arranged with respect to each other in such a way that a pressure loss of the air streaming against the rinse-around body can be kept as low as possible. As a result, the air treatment apparatus according to the disclosure can be operated particularly efficiently. For example, the pressure loss can be adjusted via the distance, in particular horizontal distance, which is also a measure of the size of the precipitator chamber, between emission electrodes and counter electrode. For the present purposes of use, in particular in enclosed spaces, especially in non-industrial use, it is sufficient to dimension the electrostatic precipitator significantly smaller than the rinse-around body as such with respect to the separating chamber. In this way, energy can be saved and a particularly efficient and at the same time effective air treatment apparatus can be produced.

In a further exemplary embodiment of the apparatus according to the disclosure, the rinse-around body has, in particular, a lower and/or circumferential liquid drip-off and/or liquid flow-off edge and a fluid return for returning the liquid, which may be loaded with precipitated particles, to the liquid reservoir and/or an annular edge surrounding the liquid drip-off and/or liquid flow-off edge. The liquid drip-off and/or liquid flow-off edge can be set in such a way that the liquid in particular loaded with precipitated particles leaves the rinse-around body at it. For example, the liquid possibly loaded with precipitated particles passes from the liquid drip and/or liquid flow-off edge into the fluid return and finally into the liquid reservoir. The annular edge may be assigned to the fluid return to allow selective, predetermined recirculation of the fluid.

According to an exemplary further development, the apparatus comprises an intermediate bottom on which the rinse-around body rests. The annular edge may surround the liquid drip-off and/or liquid flow-off edge such that a liquid return basin is formed between the annular edge, the rinse-around body and the intermediate bottom for selective return of the liquid to the liquid reservoir. For example, the fluid return basin may have one or more fluid return openings locally assigned to the fluid reservoir. Further, a fluid return channel may also be provided that leads from the fluid return basin into the fluid reservoir.

In another exemplary embodiment, the air treatment apparatus according to the disclosure comprises an electrical energy storage device, such as a battery or an accumulator. Accumulator is generally understood to mean a rechargeable battery. Battery operation or accumulator operation has proven advantageous in the treatment apparatus according to the disclosure if this is to be used as a small electric device or as a stand-alone electric device for building rooms.

In a further exemplary embodiment of the air treatment apparatus according to the disclosure, it comprises sensor means (sensor(s)) configured to sense or otherwise determine a parameter of the air to be treated, such as an air humidity, a fine dust concentration or the like. The sensor means may be arranged to evaluate the air to be treated inside the apparatus or to already sense, in particular measure, the air located outside the apparatus. Furthermore, the apparatus according to the disclosure may also comprise a controller for controlling the operation of the apparatus. The controller may be configured to control the operation of the apparatus as a function of the sensed parameter(s) of the air to be treated. For example, a certain air humidity can be set or a certain fine dust concentration. The controller can further be designed as a closed-loop control, so that the air treatment apparatus independently follows a controlled variable, for example, in order to set and/or maintain a desired air humidity or a desired fine dust concentration in a room according to a user input. In an exemplary embodiment, the controller includes processing circuitry that is configured to perform one or more functions of the controller.

For example, the air treatment apparatus can be operated in such a way that ozone is generated. This may remove unpleasant smells from the air to be treated and/or disinfect it. The air treatment apparatus may further be provided with an ozone filter, such as an activated carbon filter, to filter ozone back out of the treated air before it is released back into the environment. Furthermore, it is possible to release ozone unfiltered into the environment in order to be able to impose ozone on the air of the room in which the air treatment apparatus is installed and thus to be able to remove unpleasant smells and/or disinfect it. This can be ensured, for example, by the ozone filter being activated or deactivated electrically or by the ozone filter being able to be flipped on and away mechanically, for example by manual operation. For example, the ozone filter can be arranged inside the housing in the area of the air outlets or outside the housing.

In an exemplary embodiment, the air treatment apparatus according to the disclosure comprises a precipitation operating mode in which an amount x of ozone is generated during the precipitation of solid and/or liquid particles from the air to be treated, and an ozonation operating mode in which an amount y of ozone is generated which is greater than the amount x.

According to an exemplary further development, the air treatment apparatus comprises an ozone filter assigned to the treated air, wherein in particular the ozone filter is movably arranged on the housing of the air treatment apparatus, in particular is movably arranged such that the ozone filter can be activated in the precipitation operating mode and/or is positioned such that the treated air flows through it, and/or can be deactivated in the ozonization operating mode and/or is positioned such that the treated air does not stream through it.

According to a further exemplary further development, an operation and/or a position of the ozone filter is controllable, wherein in particular the ozone filter is coupled to the sensor means and/or the control means of the air treatment apparatus, in particular is coupled in such a way that the ozone filter is controllable as a function of the detected parameter of the air to be treated and/or by the control means.

For example, the electrostatic precipitator has a separating operating mode in which a particularly small amount of ozone is also generated during the separating of solid and/or liquid particles from the air to be treated. In the separation operating mode, the ozone filter is active or switched on in order to prevent ozone from escaping from the air treatment apparatus. The separation operating mode can be activated, for example, when the air treatment apparatus is in a room with people.

The electrostatic precipitator can also have an ozonization operating mode in which a larger amount of ozone is generated and which is intended to apply ozone to the room in which the air treatment apparatus is used in order to be able to disinfect and/or neutralize smells. In the ozonization operating mode, the ozone filter can be deactivated or switched off, in particular flipped away. In the ozonation operation mode, the power input to the electrostatic precipitator may be increased. Alternatively, or additionally, the amount of liquid rinsing around the rinse-around body can be reduced, in particular the liquid supply can be cut off.

For example, the ozone filter can be activated or deactivated electrically or manually, in particular switched on or off mechanically. The ozone filter can be movably, in particular pivotably, mounted or arranged on the housing of the air treatment apparatus, so that it can be activated if necessary, namely in the separation operating mode, for example by the ozone filter being placed in a stream channel of the treated air streaming out of the air treatment apparatus. For example, the ozone filter is placed in the housing immediately before or immediately after the air outlets. Furthermore, the ozone filter can be deactivated if required, namely in the ozonization operating mode, and/or allow the treated air loaded with ozone to flow unfiltered out of the air treatment apparatus into the environment. For example, the ozone filter can be flapped away from the air outlet.

In an exemplary embodiment, the ozone filter may be electrically controlled. For example, the ozone filter may be coupled to the sensor means and/or the controller for operating the apparatus. The controller may be configured to control or adjust the position or operating mode of the ozone filter depending on the sensed parameter(s) of the air to be treated and/or of the treated air. For example, if it is determined by the sensor means that the room air contains a predetermined limit of constituents in the air, such as bacteria, viruses, bacilli or the like, the controller may cause the ozone filter to be deactivated or positioned such that the treated air can enter the environment unfiltered in order to apply ozone to the room air.

If the air treatment apparatus according to the disclosure is operated with the electrostatic precipitator switched off, the air treatment apparatus is used primarily for air humidification. The incoming air continues to be exposed to the rinse-around liquid flowing around the rinse-around body, and is finally discharged from the apparatus toward the environment.

According to a further aspect of the present disclosure, which can be combined with the preceding aspects and exemplary embodiments, there is provided a method for treating, in particular cleaning, humidifying and/or washing air, in particular room and/or building air or air, for example, in a vehicle interior. In the process according to the disclosure, a liquid film is formed which moves at least intermittently, in particular continuously, and solid and/or liquid particles are electrically precipitated into the liquid film from the air to be treated.

According to an exemplary embodiment of the method according to the disclosure, the method is arranged to proceed according to one of the exemplary embodiments or one of the aspects of the air treatment apparatus according to the disclosure.

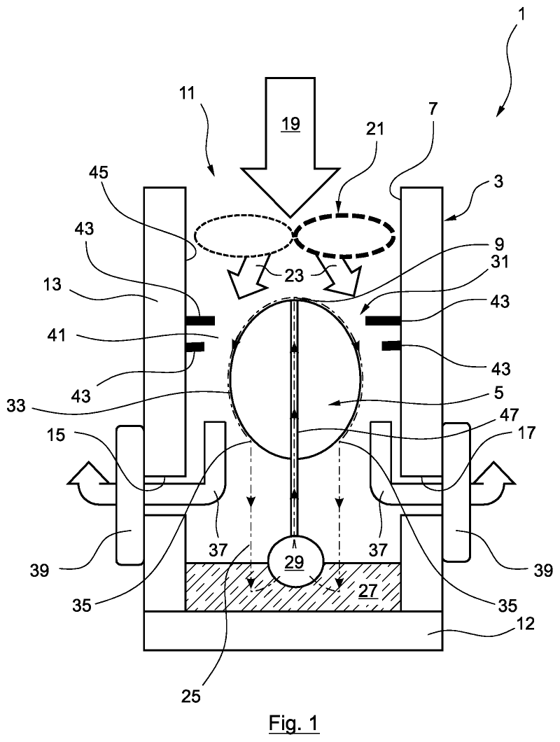

In the following description of exemplary embodiments, an apparatus according to the disclosure for treating air is generally designated by reference numeral 1. The apparatus 1 for treating air, hereinafter also referred to as air treatment apparatus 1, can perform various functions depending on the operating mode or by simple design extension, namely an air humidification, an air cleaning, an air washing as well as a particle separation, which makes the air cleaning particularly effective. For the description of exemplary embodiments on the basis of FIGS. 1 to 6, it can be assumed by way of example that the air treatment apparatus 1 is a stand-alone device or a small electrical device which is intended primarily to be placed in building rooms, for example on a table or on a shelf.

FIG. 1 shows a schematic diagram of an air treatment apparatus 1 to illustrate its operation. The main components of the air treatment apparatus 1 shown in FIG. 1 are essentially: a housing 3; a rinse-around body 5; an air conduction system 7; and an electrostatic precipitator 9. The housing 3 shown in FIG. 1 is open at the top, as an example, and otherwise comprises a base 12 and a circumferential side wall 13. All the components of the air treatment apparatus 1 according to the disclosure are received or are accommodated within the housing 3. The air conduction system 7 serves to supply the rinse-around body 5 with the air to be treated. According to FIG. 1, the air conduction system 7 comprises at least one air inlet 11 which is formed through the housing opening which is open towards the top. Furthermore, the air conduction system may be designed to discharge the treated air from the apparatus 1 again, which is realized by, for example, two housing passages 15, 17, called air outlets, in the side wall 13.

The general function of the air treatment is as follows: Via the air conduction system 7, air, in particular ambient air from a building space or, for example, from a vehicle interior, enters the air treatment apparatus 1. The incoming air is indicated by the arrow with the reference sign 19.

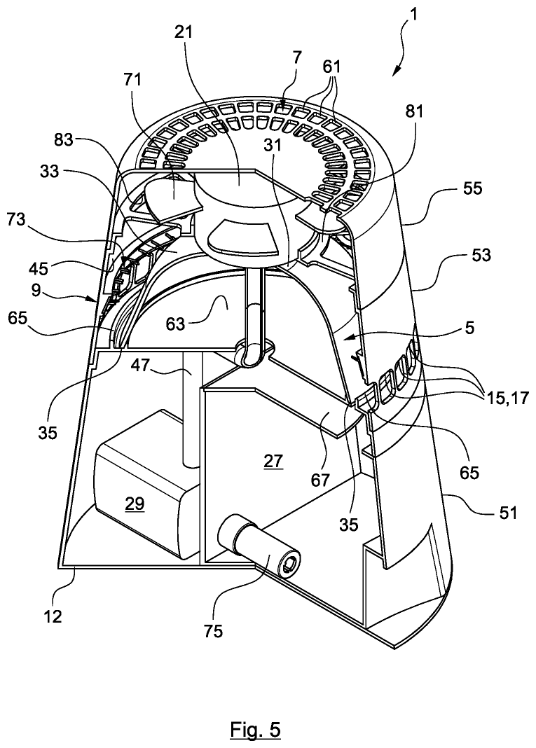

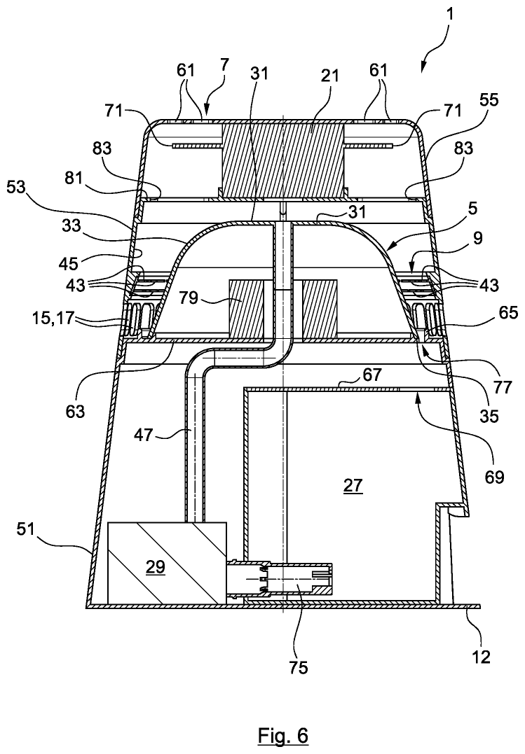

In the area of the air inlet 11, an air conveying device 21, such as an air suction device, for example a fan, can be arranged to actively suck air from the environment into the apparatus 1. Starting from the fan 21, the air is directed towards the rinse-around body 5 to stream around it, which is indicated by the arrows with reference signs 23. According to the schematic illustration in FIG. 1, the rinse-around body 5 is rotationally symmetrically shaped and convexly curved, in particular it has an oval cross-sectional shape. The rinse-around body 5 is, as indicated schematically by the dashed arrows 25, in particular continuously rinsed by liquid to form a liquid film on the rinse-around body 5, in particular a continuously flowing liquid film. The liquid can originate, for example, from a local liquid reservoir 27, which is also arranged in the housing 3, namely below the rinse-around body 5. By means of a liquid conveying device 29, which can be a pump, for example, and to which a valve device 75 (FIG. 5) can be connected, for example, liquid is conveyed from the liquid reservoir 27 to a vertically upper side 31 of the rinse-around body, which forms a kind of distribution surface. From this distribution surface 31, the liquid flows around the rinse-around body 5, in particular uniformly. For example, the liquid, which may also be referred to as rinse-around liquid, flows off, in particular uniformly, at the surface, which may be referred to as the flow-off surface 33, of the rinse-around body 5. According to the embodiments in FIG. 1, a fluid circuit is formed so that the fluid rinsing around the rinse-around body 5 can return to the fluid reservoir 27 after rinsing around the rinse-around body 5. For example, the rinse-around fluid may flow and/or drip toward the fluid reservoir 27 at a fluid flow-off and/or drip-off edge marked by the reference sign 35. An exemplary fluid return 77 is shown in particular in FIG. 6. In this way, the air to be treated streaming against the rinse-around body 5, indicated in particular by the reference sign 23, can be humidified and finally returned to the environment via the air outlets 15, 17. The air flow outlet is schematically indicated by the curved arrows with the reference signs 37. In the area of the air flow outlets 15, 17, an ozone filter 39 may be arranged to filter ozone from the air.

According to the disclosure, the electrostatic precipitator 9 is assigned to the rinse-around body 5 in such a way that solid and/or liquid particles can be precipitated from the air 19, 23 to be treated. When streaming past the electrostatic precipitator 9 and the rinse-around body 5, i.e. when streaming through a precipitator chamber 41 formed between the rinse-around body 5 and the electrostatic precipitator 9, the air to be treated is not only humidified by the rinse-around liquid, but also subjected to particle separation in order to additionally clean it. For example, due to the electrostatic precipitator 9, it is also possible to remove fine dust/small solid particles from the air to be treated, which have been perceived and classified as particularly critical and harmful.

A further advantage of the air treatment apparatus according to the disclosure is that the precipitated liquid and/or solid particles are transferred into the rinse-around liquid and are transported away by the latter or from the rinse-around body 5. On the one hand, this prevents the rinse-around body 5 from becoming contaminated and/or clogged with particles. On the other hand, a selective discharge of the particles to be separated is ensured, namely into the liquid reservoir 27. It may be provided that the liquid in the liquid reservoir 27 is replaced, for example by a complete disassembly of a liquid basin receiving the liquid reservoir, such as a drawer or the like, or without disassembly of the air treatment apparatus 1, for example by sucking off the liquid loaded with particles and supplying a clean liquid again. The electrostatic precipitator 9 comprises a plurality of emission electrodes 43, which are arranged on an inner side 45 of the housing and project toward the rinse-around body 5 and face the rinse-around body 5. With respect to a vertical direction, the emission electrodes 43 are attached to the housing 3 in the region of an upper half of the rinse-around body 5, in particular in the region of an upper third of the rinse-around body 5.

Advantageously, the rinse-around body 5 is made of an electrically conductive material such as metal, in particular stainless steel, and forms the counter-electrode of the electrostatic precipitator 9. A high-voltage electric field can be generated between the emission electrodes 43 and the counter-electrode, i.e. the rinse-around body 5, in order to electrically charge the particles in the air. During operation of the air treatment apparatus 5, and in particular during operation of the electrostatic precipitator 9, the charged solid and/or liquid particles are attracted to the rinse-around body 5 acting as a counter-electrode, so that the particles can thus be supplied to the liquid due to the electrostatic force or attraction and thereby precipitated or separated from the air to be treated.

As can be seen in FIG. 1, the pump 29 is fluidly coupled to a fluid channel 47 to pump or deliver the fluid from the fluid reservoir 27 to the distribution surface 31.

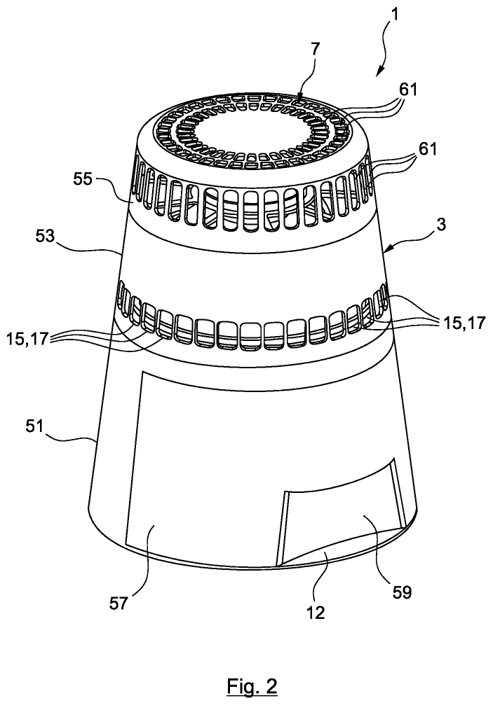

With reference to FIGS. 2 to 4, an exemplary embodiment of an air treatment apparatus 1 as a stand-alone device is described. In order to avoid repetition, reference is made to the descriptions relating to FIG. 1, in particular with regard to the mode of operation and the basic structure. In the following description, identical or similar components are provided with identical or similar reference numerals.

According to FIGS. 2 to 4, the air treatment apparatus 3 according to the disclosure comprises a multi-part housing 3. The multi-part housing 3 is essentially divided into three sections, namely a bottom part 51, a precipitator housing 53 assigned to the rinse-around body 5 and the electrostatic precipitator 9, and an air conduction housing part 55 assigned to the air conveying device 21. Furthermore, the bottom housing part 51 is also multi-part and can be partially demounted from the remaining housing parts. A fluid housing part 57 comprising the fluid reservoir 27 can be removed from the bottom housing part 51 in a drawer-like manner, for example, to replace the fluid and/or to gain access to the interior of the air treatment apparatus 1. The fluid housing 57 may comprise, for example, an actuation recess 59 by means of which the fluid housing part 57 may be easily demounted and remounted. The individual housing parts 51 to 57 can be attached to each other, for example, by means of form-fit, snap-in and/or plug-in connections.

According to the air conduction system 1 of FIGS. 1 to 4, the air conduction system 7 comprises a plurality of air passage recesses 61 formed in the air conduction housing 55, via which the air to be treated can enter the housing 3 of the air conduction system 1. The air passage recesses 61 may be positioned both radially with respect to an axis of rotation of the fan 21 and vertically above the fan 21, in order to be able to draw in as much air as possible. In the region of the precipitator housing 53, the air outlet openings 15, 17 are provided in the housing 3, in particular in a circumferential manner, and enable the air to be treated to leave the air treatment apparatus 1 or the housing 3 again after treatment and/or particle separation.

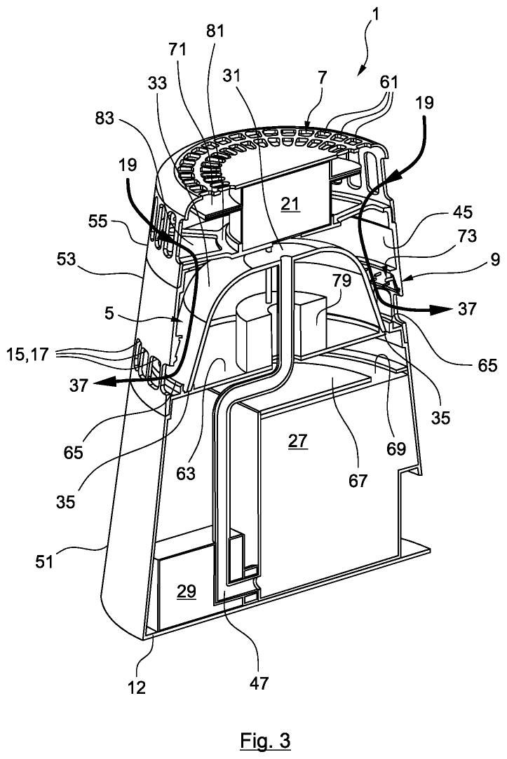

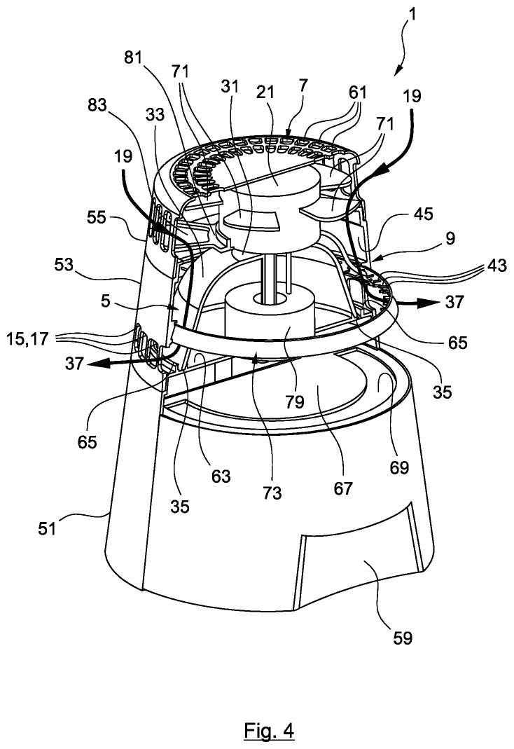

On the basis of the partial view according to FIG. 3 and the partial view according to FIG. 4, respectively, the exemplary design of the air treatment apparatus of FIG. 2 is described in more detail. The liquid reservoir 27 occupies approximately half of the volume enclosed by the bottom housing part 51. Starting from the liquid reservoir 27, a liquid channel 47 runs in the direction of the rinse-around body 5 and opens at its highest point into a distribution surface 31, from which the liquid distributes in particular uniformly on the rinse-around body 5 in order to form in particular a continuously flowing liquid film on the latter. According to FIGS. 3 and 4, the rinse-around body 5 is shaped like an umbrella or dome and is curved outwardly so that the liquid arriving on the distribution surface 31 can flow off the rinse-around body 5 substantially automatically, that is, substantially exclusively under the action of the weight force. As can be seen in FIGS. 3 and 4, the rinse-around body 5 is substantially hollow. The fluid channel 47 extends substantially through a center of the rinse-around body 5, which is in particular rotationally symmetrical. The rinse-around body 5 rests on an intermediate bottom 63, which forms a roof of the bottom housing part 51.

At its lower end, the rinse-around body 5 may form a circumferential liquid drip-off and/or liquid flow-off edge 35, from which the liquid no longer flows off the rinse-around body 5 or rinses around it. The liquid drip-off and/or liquid flow-off edge 35 is surrounded by an annular edge 65, in particular a circumferential annular edge 65, which projects from the intermediate bottom 63 and the height of which is adapted to a liquid column of the liquid rinsing around the rinse-around body 5, which forms on the intermediate bottom 63. Between the annular edge 65, the rinse-around body 5 and the intermediate bottom 63, an annular liquid basin is formed which is in fluid communication with the liquid reservoir 27. For example, an upper boundary 67 of the fluid reservoir 27 may be recessed, wherein a recess 69, in particular a surrounding annular recess 69, is arranged such that fluid flowing off or dripping off from the fluid basin may return to the fluid reservoir 27 via the recess 69. For example, fluid return openings are provided in the fluid basin. An electronic component (power supply) 79 configured to supply power is schematically indicated and arranged in the center of the hollow rinse-around body 5.

The air conduction is schematically indicated by a thick arrow starting with reference sign 19, which stands for the air to be treated to be introduced into the air treatment apparatus, and ending with reference sign 37, which stands for the treated air to be discharged from the air treatment apparatus 1. In the upper region, in which the fan 21 is arranged and in which the air 19 can be introduced into the air treatment apparatus 1 via the air passage recesses 61 of the air conduction system 7, fan blades 71 of the fan 21 can be arranged and rotate in a rotational manner about its axis of rotation, which passes, for example, through the center of the rinse-around body 5. From the fan 21, the air 23 to be treated is conveyed directly toward the rinse-around body 5 to come into contact with the liquid. In this way, air humidification is realized, because the humidified air can subsequently leave the air treatment apparatus 1 again via the air outlets 15, 17 and be supplied to the environment.

On the way downstream of the fan 21 and upstream of the air outlets 15, 17, the air to be treated is subjected to a particle separation process initiated and carried out by the electrostatic precipitator 9. Looking at FIGS. 3 and 4 together, it can be seen that an emission electrode array 73 extending in an annular shape around the rinse-around body 5 is attached to an inner side 45 of the housing 3. The emission electrode array 73 interacts with the rinse-around body 5, which acts as a counter-electrode, to build up a high-voltage electric field, in particular in the space between the rinse-around body 5 and the emission electrode array 73. The air 23 to be treated streaming through the high-voltage electric field can thus be fed to a precipitation process. During the precipitation process, any solid and/or liquid particles present in the air 23 to be treated are electrically charged by the electrostatic precipitator 9 and can thus be electrostatically attracted by the rinse-around body 5 acting as a counter-electrode in the further stream course of the air 23 to be treated from the air flow, which leaves the housing 3 again via the stream outlets 17, 15 in accordance with reference numeral 37. The electrical attraction to the particles to be precipitated, which are in particular negatively charged, causes the precipitation respectively separation of the air stream and the particle additive. The liquid film (not shown) formed in particular continuously on the flow-off surface 33 of the rinse-around body 5 is intended to receive and carry the precipitated particles, in particular after the particles, which are in particular negatively charged, have again discharged their charge at the counter electrode 5. Subsequently, the liquid which may have been loaded particles can be transported back into the liquid reservoir 27 by means of the liquid return 77 described above. The treated air 37 is thus humidified and/or cleaned, in particular freed, from particles.

With reference to FIGS. 5 and 6, a further exemplary embodiment of an air treatment apparatus 1 is described. The air treatment apparatus 1 is designed substantially analogously to the air treatment apparatus 1 of FIGS. 2 to 4. In this respect, the description essentially deals with the aspects or details not illustrated in FIGS. 2 to 4. Identical or similar components are provided with identical or similar reference numerals.

In FIGS. 5 and 6, it can be seen that the pump 29 disposed outside the fluid reservoir 27 is in fluid communication with the fluid disposed in the fluid reservoir 27 via a valve means 75 which projects into the fluid reservoir 27. In particular, in FIG. 6, the exemplary embodiment of the precipitator housing part 53 can be seen, according to which it forms an upper intermediate bottom 81, on which, on the one hand, the fan 21 is arranged and which has air ducts 83 for the passage of the said air 19 to be treated. Referring again to FIG. 6, the liquid return 77 is visible. This is formed as a recess, opening or passage in the lower intermediate bottom 63, on which the rinse-around body 5 is arranged and which delimits the liquid return basin. From a synopsis of FIGS. 5 and 6, it can be seen that the intermediate bottom 63 is formed completely closed in a region which does not face the liquid reservoir 27, and that the intermediate bottom 63 is open in the section assigned to the liquid reservoir 27, in particular arranged vertically above it, in particular where the recess 69 is provided in the upper boundary 67 of the liquid reservoir 27, so that the liquid, which may be contaminated with particles, can flow or drip down back into the liquid reservoir 27.

In contrast to the previous embodiments, the air treatment apparatus 1 according to FIGS. 5 and 6 does not comprise any lateral air passage recesses 61 in the housing part 55, but only on the vertical upper side.

The features disclosed in the foregoing description, the figures and the claims may be significant both individually and in any combination for the realization of the disclosure in the various embodiments.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the term “processing circuitry” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein. In one or more of the exemplary embodiments described herein, the memory is any well-known volatile and/or non-volatile memory. The memory can be non-removable, removable, or a combination of both.

### REFERENCE LIST

1 Air treatment apparatus
3 Housing
5 Rinse-around body
7 Air conduction system
9 Electrostatic precipitator
11 Air inlet
12 Bottom
13 Side wall
15, 17 Air outlet
19 Air to be treated
21 Air conveying device
23 Air to be treated downstream of an air conveying device
25 Liquid circuit
27 Liquid storage
29 Liquid conveying device
31 Distribution surface
33 Flow-off surface
35 Liquid drip-off and/or flow-off edge
37 Treated air
39 Ozone filter
41 Precipitator chamber
43 Emission electrode
45 Inner side of the housing
47 Liquid channel
51 Bottom housing part
53 Precipitator housing part
55 Air conduction housing part
57 Fluid reservoir housing part
59 Actuation recess
61 Air passage recess
63 Intermediate bottom
65 Annular edge
67 Upper limit of the liquid storage tank
69 Recess
71 Fan blade
73 Emission electrode array
75 Valve means
77 Liquid return
79 Electronic component (power supply)
81 Upper intermediate bottom
83 Air duct

1. An apparatus adapted to treat air, comprising:
a rinse-around body configured such that liquid rinses around the rinse-around body;
an air conduction system configured to stream the air to be treated against the rinse-around body; and
an electrostatic precipitator associated with the rinse-around body and configured to precipitate solid and/or liquid particles from the air to be treated streaming against the rinse-around body and cause the precipitated particles to enter the liquid.

2. The apparatus according to claim 1, further comprising: a local liquid reservoir configured to be arranged below the rinse-around body and/or removably mountable in the apparatus.

3. The apparatus according to claim 2, wherein the liquid reservoir is integrated into a liquid circuit configured to return the liquid to the liquid reservoir after rinsing around the rinse-around body.

4. The apparatus according to claim 1, wherein the rinse-around body is configured such that an at least intermittently moving liquid film completely surrounds the rinse-around body.

5. The apparatus according to claim 1, wherein the rinse-around body:
is convexly curved at least in sections,
is rotationally symmetrically shaped, and/or
includes an umbrella-like or dome-like flow-off surface.

6. The apparatus according to claim 1, wherein the rinse-around body is rotationally symmetrically formed and comprises a central distribution surface configured to uniformly spread out the liquid to flow off the rinse-around body.

7. The apparatus according to claim 6, further comprising:
a central opening in the distribution surface, the central opening being fluidly connected to the liquid reservoir via a liquid channel, and
a pump integrated into the liquid channel and configured to pump the liquid from the liquid reservoir via the liquid channel and through the central opening to the distribution surface.

8. The apparatus according to claim 1, further comprising a pump configured to continuously convey the liquid from the liquid reservoir to a highest point of the rinse-around body to continuously rinse the rinse-around body.

9. The apparatus according to claim 1, wherein the air conduction system comprises a fan arranged above the rinse-around body and configured to suck in air from an environment and/or to convey the air in a direction towards the electrostatic precipitator.

10. The apparatus according to claim 1, further comprising a housing configured to house the rinse-around body and the electrostatic precipitator.

11. The apparatus according to claim 1, comprising a housing configured to accommodate the rinse-around body and the electrostatic precipitator, the air conduction system including a plurality of air passage recesses formed in the housing.

12. The apparatus according to claim 1, wherein the electrostatic precipitator comprises at least one emission electrode and a counter electrode, the counter electrode being formed by the rinse-around body, wherein the rinse-around body is formed from an electrically conductive material.

13. The apparatus according to claim 12, wherein the at least one emission electrode is associated with the rinse-around body and configured such that particles separated from the air are attracted by the rinse-around body.

14. The apparatus according to claim 1, wherein the electrostatic precipitator comprises a plurality of emission electrodes arranged around the rinse-around body, wherein the rinse-around body is rotationally symmetrical.

15. The apparatus according to claim 12, wherein the at least one emission electrode is arranged in a region from a highest point of the rinse-around body to half of an axial height of the rinse-around body.

16. The apparatus according to claim 1, wherein the rinse-around body comprises:
a liquid drip-off at which the liquid leaves the rinse-around body, and
a fluid return configured to return the liquid into the liquid reservoir and/or an annular edge surrounding the liquid drip-off.

17. The apparatus according to claim 16, wherein the annular edge surrounds the liquid drip-off such that a liquid return basin for a predetermined return of the liquid into the liquid reservoir is formed between the annular edge, the rinse-around body, and an intermediate bottom on which the rinse-around body is disposed.

18. The apparatus according to claim 1, wherein the apparatus is configured to house an electric energy storage device.

19. The apparatus according to claim 1, comprising:
a sensor configured to detect a parameter of the air to be treated, and
a controller configured to control the apparatus based on the detected parameter.

20. The apparatus according to claim 1, wherein the apparatus is configured to operate in:
a precipitation operating state in which a first amount of ozone is generated during precipitation of solid and/or liquid particles from the air to be treated, and
an ozonization operating state in which a second amount of ozone is generated, the second amount of ozone being greater than the first amount of ozone.

21. The apparatus according to claim 20, further comprising an ozone filter configured to filter the treated air, wherein the ozone filters is movably arranged on a housing of the air treatment apparatus, the ozone filter being configured to be activated in the precipitation operating state and deactivated in the ozonization operating state.

22. The apparatus according to claim 21, further comprising a sensor configured to detect a parameter of the air to be treated, and a controller configured to control an operation and/or a position of the ozone filter based on the detected parameter of the air to be treated.

23. A method for treating air, comprising:
forming a film that moves at least intermittently on a rinse-around body; and
electrically precipitating solid and/or liquid particles into the liquid film from the air to be treated using an electrostatic precipitator.

24. (canceled)
